(19) United States
(12) Patent Application Publication
(10) Pub. No.: US 2009/0013369 A1
(43) Pub. Date: Jan. 8, 2009

(54) Device and Method for Initializing Decoder in Digital Broadcasting Receiver

(75) Inventors: Jeong-Wook Seo, Suseong-gu Daegu (KR); Wei-Jin Park, Seoul (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city, Gyeonggi-do (KR)

(21) Appl. No.: 11/912,886

(22) PCT Filed: Apr. 28, 2006
(86) PCT No.: PCT/KR06/01612

§ 371 Date: Jun. 30, 2008

(30) Foreign Application Priority Data
Apr. 28, 2005 (KR) 10-2005-35725
Apr. 28, 2006 (KR) 10-2006-38452

(51) Int. Cl. H04N 7/173

(52) U.S. Cl. 725/131

(57) ABSTRACT

Disclosed is a digital broadcasting transmitter/receiver. The digital broadcasting transmitter/receiver includes a tuner for selecting a channel of a received digital broadcasting signal through channel selection by a controller unit, a demodulator for demodulating a signal of the selected digital broadcasting channel, a demultiplexer for separating audio, video and data streams of a selected program identifier from the demodulated broadcasting signal to demultiplex the streams to corresponding decoders, respectively, and issuing a decoding operation command when a frame header is detected in the respective streams, a video decoder for decoding a demultiplexed video frame when the decoding operation command is issued, an audio decoder for decoding a demultiplexed audio frame when the decoding operation command is issued, and a display unit for displaying decoded video and audio data.

### TECHNICAL FIELD

The present invention relates to a decoding apparatus and a decoding method in a digital broadcast receiver for a portable terminal, and more particularly to an apparatus and a method for initializing a decoder in a digital broadcast receiver.

### BACKGROUND ART

In general, a current potable terminal shows a tendency to mount a dedicated multimedia processor therein or to strengthen its multimedia functions. In recent years, technologies for providing a portable terminal with a television function have been published, and research is currently being pursued to mount a digital broadcasting receiver in a portable terminal. Thus, a current portable terminal must be so constructed that it can service various multimedia functions. On account of this, constructions and processing procedures of a portable terminal becomes more and more complicated.

Standardization for digital broadcasting is now actively being discussed over the whole world. The digital broadcasting is largely divided into a Digital Multimedia Broadcasting (DMB) scheme used in USA and a Digital Video Broadcasting (DVB) scheme used in Europe. A portable terminal with a digital broadcast receiver of the DMB or DVB scheme includes a tuner, a demodulator, a decoder and so forth. Here, the tuner, the demodulator and the decoder for digital broadcasting reception are constructed differently from a Radio Frequency (RF) unit, a demodulator and a decoder of the portable terminal, respectively. That is, the digital broadcast receiver uses frequency different from communication frequency of the portable terminal, and also uses different demodulation and decoding schemes from those of the portable terminal. In this way, since a digital broadcast receiver must be additionally provided in a portable terminal, the size of the portable terminal is inevitably enlarged.

FIG. 1 illustrates an architecture of a digital broadcast receiver. In FIG. 1, a digital broadcast receiver has an architecture including an RF tuner 110, a demodulator 120 and a decoder 130.

Referring to FIG. 1, a digital broadcast signal may be a VHF band (174 to 230□: C5-C12) signal and/or a UHF band (470 to 862□: C21-C69) signal and/or a L-band (1452 to 1492□) signal. If a user selects a broadcast channel, a controller 100 outputs control data corresponding to the channel selected in the RF tuner 110. Also, the RF tuner 110 generates and mixes RF frequency according to the channel control data, thereby generating an Intermediate Frequency (hereinafter referred to as “IF”) signal of the selected channel. Here, IF may be 36.17□. This IF frequency signal is applied to the demodulator 120. Then, the demodulator 120 demodulates and outputs the received signal in a predetermined demodulation scheme. Here, it is assumed that a signal outputted from the demodulator 120 is an MPEG-2 TS (Transport Stream) signal, and this output signal is applied to the decoder 130. Then, the decoder separates the received MPEG-2 TS signal into video, audio and data, decodes each of them, and then outputs them into an video signal and an audio signal. At this time, the video signal may be an RGB signal, a YUV signal or the like, and the audio signal is generally outputted in the form of a PCM stereo sound. The video signal outputted from the decoder 130 is outputted to and displayed on a display 150, and the audio signal is applied to and reproduced by a speaker 160.

Hereinafter, the decoder 130 in the digital broadcast receiver having the above-mentioned architecture will be discussed. FIG. 2 illustrates an architecture of the decoder 130.

Referring to FIG. 2, a demultiplexer unit 210 performs a function of receiving demodulated MPEG-2 TS data outputted from the demodulator 120 to separate the data into audio, video and other data. At this time, the controller 100 selects information on broadcasting to be chosen in the demultiplexer unit 210, that is, a Product ID (hereinafter referred to as “PID”) to inform the demultiplexer unit 210 of the information, and accordingly the demultiplexer unit 210 chooses target data according to the selected PID, from among various data outputted from the demodulator 120, to separate the chosen data into video and audio. An input buffer 220 corresponding to a general queue (it has a similar structure to an FIFO structure and may be a kind of a circular buffer in which inputting and outputting are oppositely effected) functions to store data, which is demultiplexed in real-time, by the amount of data which can be processed by a video decoder 230 and an audio decoder 250 downstream thereof. The video decoder 230 takes charge of decoding the video data. It is common that the digital broadcast receiver receives an MPEG-2 video Elementary Stream (hereinafter referred to as “ES”) to convert it into YUV 4:2:0 data. However, since the video signal is outputted suitably to the display (LCD) of the digital broadcast receiver, the video data may be converted into RGB data. The audio decoder 250 takes charge of decoding the audio signal, and receives an MPEG-2 audio ES to convert it into PCM audio in a similar manner to the video decoding. The converted PCM audio signal is stored in an audio output buffer 270 and then is outputted at a corresponding outputting time point.

In the digital broadcast receiver having the above-mentioned architecture, the video decoder 230, the audio decoder 250 and other data decoders (not illustrated) perform decoding operations in units of frame data, respectively. At this time, the decoders 230 and 250 buffer the video and audio data, which are outputted from the demultiplexer 210, in units of a frame, and then perform the decoding operations, respectively.

FIG. 3 is flowchart illustrating decoding procedures in the decoders 230 and 250.

Referring to FIG. 3, in step 311, the video decoder 230 analyzes data stored in the input buffer 220. When the stored data is not sufficient to be decoded, the video decoder 230 goes to step 313 to stand by until frame-sized video data is buffered. In the course of repeatedly performing these operations, if video data sufficient to be decoded is buffered in the input buffer 220, the video decoder 230 detects this in step 311, and starts to decode the video data stored in the input buffer 220 in step 315. Upon completion of decoding the frame-sized video data, the video decoder detects this in step 317, and returns to repeatedly perform the operations as stated above.

FIG. 4 illustrates a frame structure of video data which is received in a digital broadcast receiver.

Referring to FIG. 4, first, a video sequence layer shown in FIG. 4a is a video data group having a series of the same attributes. One of major functions of a sequence header included in the video sequence layer is a function to enable reproduction in the middle of a bitstream. That is, the sequence header is a place in which general basic information for MPEG2 exists, and contains a sequence start code followed by information on horizontal and vertical picture sizes, a pixel aspect ratio, a picture rate, a bit rate Video Buffering Verifier (VBV) buffer size, a graphics parameter flag, a flag for loading two quantization matrices, and others. Secondly, a Group Of Pictures (hereinafter referred to as “GOP”) layer shown in FIG. 4b is the smallest unit of a GOP, as a random access unit, and contains information for edition, a period of time from the start of the sequence, and so forth. In the GOP layer, a start code is followed by plural flags (time_code flag, closed_GOP flag, broken_link flag). Thirdly, a picture layer shown in FIG. 4c sets characteristics common to one piece of picture, such as a picture coding mode, a picture type, etc. Similar to MPFG1, there is a D picture having only DC components used for fast forward, fast rewind and the like, and the picture type consists of I, P and B pictures. In the picture layer, a start code is followed by a temporal reference indicating picture sequence in the GOP, the picture type, a flag indicating whether or not an encoder or a motion vector is an integer encoder or an integer motion vector, a frame interval of a motion vector (F_code), etc. Fourthly, a slice layer shown in FIG. 4d contains information common to small pictures of any length, into which one piece of picture is divided, for example, a quantization characteristic value. The slice layer corresponding to the smallest unit of a series of data rows having a start code is a strip of macroblocks, and cannot extend over various pictures. The first macroblock and the last macroblock cannot be skipped and, when a slice consists of one macroblock, the one macroblock cannot be skipped. Overlapping or skip between slices is not allowed, the vertical location of a slice is contained in the slice's start code itself, and the horizontal location of a leading macroblock in the slice is represented using a macroblock address of a macroblock layer. Fifthly, a macroblock layer shown in FIG. 4e is a layer in which a plurality of block layers as shown in FIG. 4f, in general, four block layers are link with each other. The macroblock layer contains information common to pixel blocks, into which the slice layer is further divided, such as motion correction, motion vector value, etc. In the macroblock layer, any number of sets of a macroblock stuffing, a macroblock escape, a macroblock address (MBA), a macroblock type and so forth successively follow one after another. Finally, a block layer shown in FIG. 4f is the smallest unit of transmission and compression, and contains a necessary IDCT coefficient and ends with an End of Bock (EOB). Even when the number of VLCs of the IDCT coefficient is 10, the EOB is added. An intra DC uses its own VLC, and others are expressed by a two-dimensional VLC.

Therefore, a header analyzer unit of the video decoder 230 separates packets on a layer-by-layer basis from the MPEG2 video ES structure shown in FIGS. 4a to 4f to analyze a sequence header, a GOP header, a picture header, a slice header and a macroblock header. From a result of analyzing the headers, information on a frame rate, a picture size, a picture coding type (I frame, P frame, B frame), a GOP sequence (configuration sequence of I/P/B frames presented in MPEG2 standards, for example, IBBPBBPBBP or IBPBPBPBPBP), etc. are confirmed, and the confirmed information can be used for a subsequent decoding procedure. As stated above, in step 311, the video decoder 230 checks if video data buffered in the input buffer 220 reaches one frame size.

### DISCLOSURE OF INVENTION

### Technical Problem

At this time, in order to recognize the one frame size, the video decoder 230 must confirm a sequence end head of a current video sequence as shown in FIG. 4a or search for a sequence header of a next video sequence. That is, the video decoder 230 must continually confirm the last data of a current video frame or continually scan whether or not a sequence header of a next video sequence is inputted. Thus, each of the video decoder 230, the audio decoder 250 and the data decoders of the prior art continually scans data, which is demultiplexed in the demultiplexer 210, and performs decoding operations if buffered data reaches a given size (one frame size). Consequently, when decoding operations are performed in the conventional digital broadcast receiver, there is a problem in that decoders are heavily burdened and the decoding operations become complicated because the decoding operations are performed only after the decoders confirm the reception of decodable-sized data.

### Technical Solution

Accordingly, the present invention has been made to solve at least the above-mentioned problems occurring in the prior art, and an object of the present invention is to provide an apparatus and a method in a digital broadcast receiver, which can check whether to receive frame data at decoding, and accordingly control operations of decoders.

A further object of the present invention is to provide an apparatus and a method in a digital broadcast receiver, which can perform decoding operations by controlling corresponding decoders at a point of time when frame data is demultiplexed while a demultiplexer demultiplexes received stream data.

A further object of the present invention is to provide an apparatus and a method in a digital broadcast receiver, which can check a frame header of a demultiplexed data frame by a demultiplexer to initialize a corresponding decoder when the frame header is confirmed.

In order to accomplish these objects, there is provided a digital broadcast transmitter/receiver comprising: a tuner for selecting a channel of a received digital broadcast signal through channel selection by a controller unit; a demodulator for demodulating a signal of the selected digital broadcast channel; a demultiplexer for separating audio, video and data streams of a selected program identifier from the demodulated broadcast signal to demultiplex the streams to corresponding decoders, respectively, and issuing a decoding operation command when a frame header is detected in the streams; a video decoder for decoding a demultiplexed video frame when the decoding operation command is issued; an audio decoder for decoding a demultiplexed audio frame when the decoding operation command is issued; and a display unit for displaying decoded video and audio data.

### ADVANTAGEOUS EFFECTS

As described above, in a digital broadcast receiver according to the present invention, a PES header processor of a demultiplexer analyzes whether or not frame headers of a received packet are received, and issues a decoding operation command to operate decoders when the frame headers are confirmed. Decoders corresponding to the confirmed frame headers perform decoding operations when receiving the decoding operation command. Accordingly, the decoders need not spend an excessive turn-on time on header search procedures other than decoding operation procedures. As a result of this, a standby time and a search procedure, which are practically unnecessary, can be omitted, and thus decoding efficiency can be improved.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an architecture of a digital broadcast receiver;

FIG. 2 is a block diagram illustrating an architecture of a decoder in FIG. 1;

FIG. 3 is a flowchart illustrating procedures of decoding video data in conventional decoders;

FIG. 4 is a view illustrating a structure of video frame data to be processed in a video decoder;

FIGS. 5a to 5c are views illustrating configurations of a received packet;

FIGS. 6a to 6c are views illustrating configurations of supplemental information contained in a received packet;

FIGS. 7a to 7d are views illustrating configurations of PES information contained in a received packet;

FIG. 8 is a block diagram illustrating an architecture of a demultiplexer in accordance with a preferred embodiment of the present invention;

FIG. 9 is a flowchart illustrating a procedure of initializing decoders in accordance with a preferred embodiment of the present invention;

FIG. 10 is a view illustrating an example of frame data which a demultiplexer distributes to decoders; and

FIG. 11 is a block diagram illustrating an architecture of a demultiplexer in accordance with another preferred embodiment of the present invention.

### BEST MODE FOR CARRYING OUT THE INVENTION

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

In the following description, specific details such as an MPEG2-TS data structure, etc. are illustrated in order to provide more general understanding of the present invention. However, it is apparent to those skilled in the art that the present invention can also be easily practiced by means of various modifications without such specific details.

The present invention aims at an decoding apparatus and a method in a digital broadcast receiver, in which decoding time points of decoders are controlled by a demultiplexer which analyzes packet data received to the digital broadcast receiver and distributes the packet data to corresponding decoders, respectively. In preferred embodiments of the present invention, there are proposed an apparatus and a method, in which a PES header processor unit of the demultiplexer detects PES headers of received packets, and informs decoders corresponding to the detected PES headers of decoding start positions to perform decoding operations.

In preferred embodiments of the present invention, it is assumed that a TS signal inputted into the digital broadcast receiver is an MPEG2-TS signal. However, regardless of whether or not the TS follows a system standard of MPEG-2, whether or not a video signal included as particular data follows any one of H.261 to H.264 or MPEG-4, and whether or not an audio signal follows any one rules MPEG-1 to MPEG-4, operations according to the preferred embodiments of the present invention can be applied in the same manner.

Now, reference will be made to the preferred embodiments of the present invention with reference to the accompanying drawings.

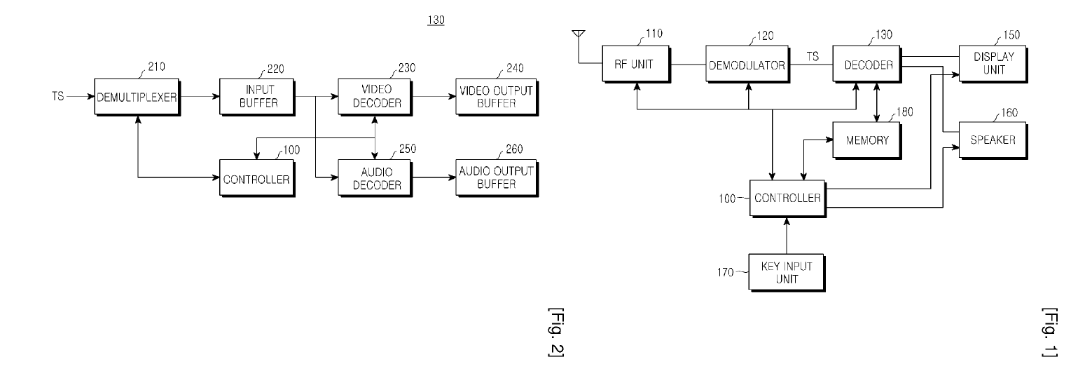

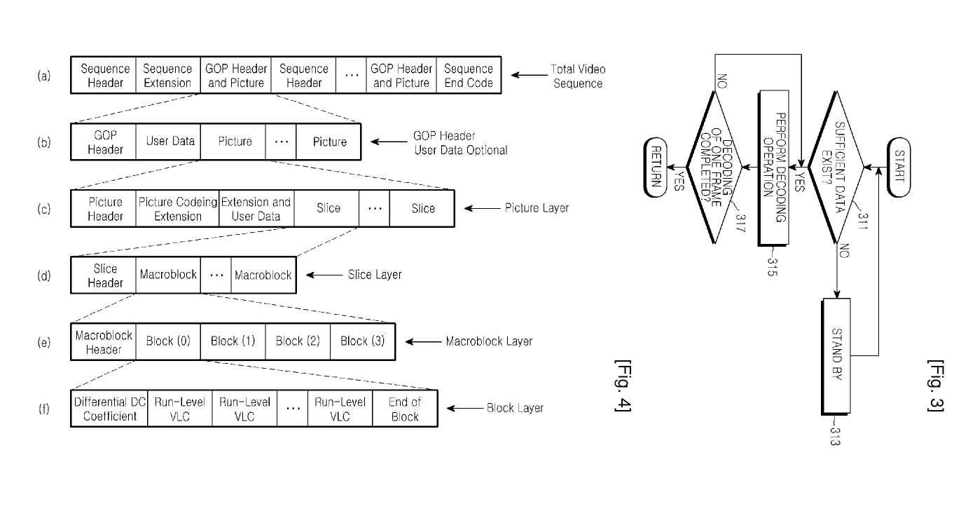

A digital broadcast receiver according to the preferred embodiment of the present invention has the same architecture as that in FIG. 1, and its operations are also performed in the same manner. Further, in the digital broadcast receiver having such an architecture, a decoder 130 may be constructed as illustrated in FIG. 2.

FIG. 8 illustrates an architecture of a demultiplexer 210 according to a preferred embodiment of the present invention.

Referring to FIG. 8, a synchronization searcher 411 detects a synchronization byte from a packet header of a received TS signal, and stores the received TS signal in an input buffer 421 when the synchronization byte is detected. Then, the input buffer 421 buffers packet-sized data. Also, a packet header processor 413 extracts the packet header from the input buffer 421 to process the extracted packet header, and outputs other data than the packet header to a buffer 423. A supplemental information processor 415 extracts supplemental information from the buffer 423 to process the extracted supplemental information, and outputs other data than the supplemental information to buffer 425. A PES header processor 417 extracts PES header information from the buffer 425 to process the extracted PES header information, and outputs other information than the PES header information to buffer 427. Also, if analyzing the packets to confirm the PES header, the PES header processor 417 according to this embodiment outputs an initialization signal to a video decoder 230, an audio decoder 250 or a data decoder (not illustrated) to initialize a decoder corresponding to the received packet, thereby controlling the decoder to get ready for decoding operations.

Further, if Multi-Protocol Encapsulation (MPE) data is contained in other data than the PES header information after the PES header processor 417 processes the PES header information, the PES header processor 417 outputs the other data including the MPE data to a corresponding buffer 1 (not illustrated). A MPE data processor (not illustrated) extracts the MPE data from the corresponding buffer 1, and processes the extracted MPE data to generate Internet Protocol (IP) data. The MPE data processor outputs the generated IP data to a corresponding buffer 2 (not illustrated). An IP data processor (not illustrated) extracts the IP data from the corresponding buffer 2, and processes the extracted IP data to generate User Define Protocol (UDP) data. The IP processor outputs the generated UDP data to a corresponding buffer 3 (not illustrated). A UDP data processor (not illustrated) extracts the UDP data from the corresponding buffer 3, and processes the extracted UDP data to generate File Delivery over Unidirectional Transport Protocol (FLUTE) data and Real-time Transport Protocol (RTP) data. The UDP data processor outputs the generated FLUTE data and RTP data to a corresponding buffer 4 (not illustrated). A FLUTE data processor (not illustrated) extracts the FLUTE data from the corresponding buffer 4, and processes the extracted FLUTE data to generate Electrical Service Guide (ESG) data and/or file data. Also, a RTP data processor (not illustrated) extracts the RTP data from the corresponding buffer 4, and processes the extracted RTP data to generate pure Audio/Video (A/V) data. The FLUTE data processor and the RTP data processor output the generated ESG data and/or file data and the generated pure A/V data to the buffer 427. A data processor 419 extracts data from the buffer 427 to output the extracted data into a video ES or an audio ES, or outputs the ESG data and/or file data and the pure A/V data from the buffer 427.

Further, if analyzing the packets to confirm the PES header, the PES header processor 417 according to this embodiment outputs an initialization signal to the video decoder 230, the audio decoder 250 or the data decoder (not illustrated) to initialize a decoder corresponding to the received packet, thereby controlling the decoder to get ready for decoding operations. Also, the IP data processor and/or the UDP data processor output/outputs an initialization signal to the video decoder 230, the audio decoder 250 or the data decoder (not illustrated) to initialize a decoder corresponding to the received packet, thereby controlling the decoder to get ready for decoding operations.

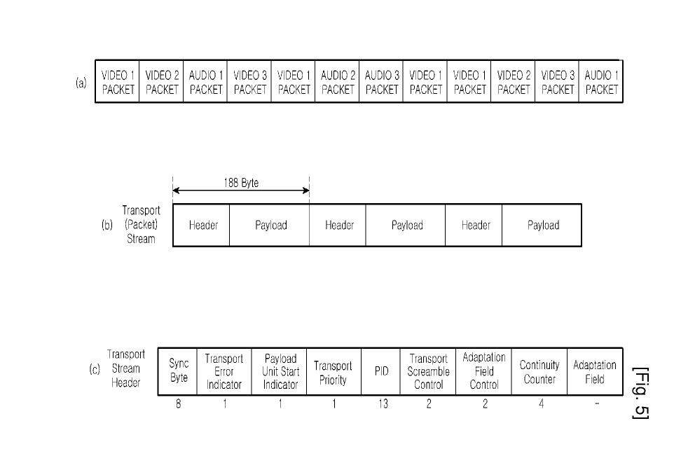

Before operations of the respective processors 413, 415, 417, 419 of the demultiplexer 210 are explained, a structure of the inputted TS signal will be discussed briefly. The TS signal is a packet stream as stated above, and consists of video packets and audio packets as illustrated in FIG. 5a or consists of video packets, audio packets and data packets (e.g., MPE, IP, etc.). At this time, the video and audio packets are randomly multiplexed in a digital broadcast transmitter and are transmitted from the digital broadcast transmitter. The video and audio packets illustrated in FIG. 5a consists of packet headers and payloads, and the packet header and the payload are configured with 188 bytes. That is, one packet data is configured with 188 bytes. The packet header has a size of 4 bytes as illustrated in FIG. 5c, and each parameter of the packet header is responsible for the following functions as shown in Table 1.

TABLE 1

| classification | description | bits |
|---|---|---|
| sync byte | synchronization byte, 0X47 | 8 |
| transport | when error occurs in current packet: 1 | 1 |
| error | | |
| indicator | | |
| payload start | when current packet is start of PES: 1 | 1 |
| indicator | | |
| transport | used in decoder | 1 |
| priority | | |
| PID | identifier classifying packet type | 13 |
| scrambling | set scrambling mode | 2 |
| control | | |
| adaptation | 01: no supplemental information/only payload exists | 2 |
| field | 10: only supplemental information exists/no payload | |
| control | 11: both supplemental information and payload exist | |
| | 00: reserved | |
| continuity | 4 byte counter, increases by 1 for the same PID | 4 |
| counter | | |

That is, the packet data begins with a sync byte, and one packet is discerned from another packet by the sync byte. The synchronization searcher 411 searches for inputted packet data to delay data inputting until a sync byte is detected. If the sync byte is detected, the synchronization searcher 411 buffers subsequently inputted packet data in the buffer 421. The 4-byte packet headers as presented in Table 1 are buffered in first to fourth byte positions of the buffer 421.

Then, the packet header processor 413 is constructed such that it processes the packet header as illustrated in FIG. 5c and presented in Table 1. That is, the packet header processor 413 compares an identifier PID (Product ID), which represents stream information on a video/audio signal of an established broadcast channel, with a PID of a TS signal outputted from the buffer 421, and controls the packet buffered in the buffer 421 not to be processed when the packet does not have the established PID. However, if the packet has the same PID value as that of the established PID, the packet header processor 413 transfers the packet data buffered in the buffer 421 to the buffer 423. That is, the packet header processor 413 analyzes received packets to transfer only packets having established PID information to the buffer 423, thereby preventing packets having different PIDs from the established PID from being demultiplexed (i.e., removing undesired packets).

*At this time, the packet header processor 413 analyzes the packet header to check if supplemental information is contained in the packet. If the packet does not contain the supplemental information, that is, if the packet consists of a PES header and/or actual data (ES), the packet header processor 413 may control the packet data stored in the buffer 423 to be transferred to the PES header processor 417 while omitting operations of the supplemental information processor 415. When the packet does not contain the supplemental information in this way, the PES header and/or the actual data are/is stored in a supplemental information storage area, that is, in an adaptation field of the packet data having the configuration as illustrated in FIG. 5c. However, if the packet data contains the supplemental information, it has the configuration as illustrated in FIG. 5c, and the supplemental information or the supplemental information and the PES header and/or the actual data ES may be contained in the adaptation field. Then, the packet header processor 413 may control the data buffered in the buffer 421 to be transferred to the supplemental information processor 415. At this time, the 4-byte packet header is removed from the data transferred to the supplemental information processor 415.

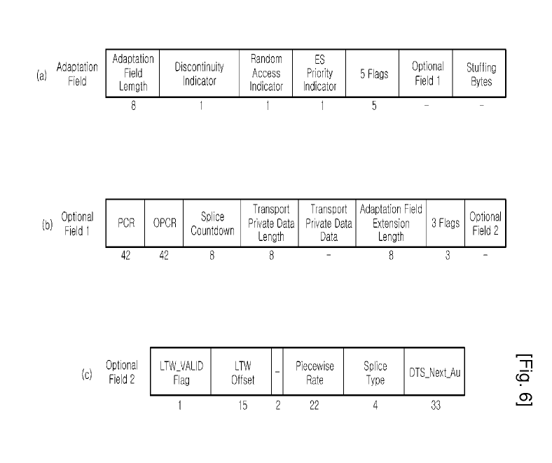

The supplemental information processor 415 processes the data contained in the adaptation field, and the data in the adaptation field has the configuration as illustrated in FIGS. 6a to 6c. FIG. 6a illustrates the configuration of a supplemental information header. The supplemental information includes information such as adaptation field length, ES priority indicator and so forth, and has flag (5 flags) parameters indicating whether to contain optional field 1 therein. At this time, when the optional field 1 is contained, a corresponding flag (or corresponding flags) of the 5 flags area as illustrated in FIG. 6a is/are set, and supplemental information corresponding to the set flag (flags) are contained in the optional field 1. The supplemental information contained in the optional field 1 is shown in Table 2, and may have a configuration as illustrated in FIG. 6b.

TABLE 2

| 5 flags | optional field 1 | bits | |
|---|---|---|---|
| 1XXXX | PCR | 42 | bits |
| X1XXX | OPCR | 42 | bits |
| XX1XX | splice count down | 8 | bits |
| XXX1X | transport private data length | 8 | bits |
| | transport private data | variable | |
| XXXX1 | adaptation field extension length | 8 | bits |

Referring to FIG. 6b, the optional field 1 contains a reference for program time information, that is, a Program Clock Reference (hereinafter referred to as “PCR”), and other supplemental information available for decoding. In table 2, optional field 1 data corresponding to each of the 5 flags is shown, and at least two of the 5 flags may be set or all the 5 flags may be set. For example, if the 5 flags are set to “10100”, PCR data and splice count down data are contained in the optional field 1.

The optional field 1 also has 3 flags indicating whether to contain optional field 2. At this time, when the optional field 2 is contained, a corresponding flag (or corresponding flags) of the 3 flags as illustrated in FIG. 6b is/are set, and supplemental information corresponding to the set flag (flags) are contained in the optional field 2. The optional filed 2 has a configuration as illustrated in FIG. 6c, and the supplemental information contained in the optional field 2 is shown in Table 3. Optional field 2 data corresponding to each of the 3 flags in FIG. 6b are shown below in Table 3, and at least two of the 3 flags may be set.

FIGS. 6a to 6c illustrate supplemental information for decoding the received packet data, which are contained only when needed.

TABLE 3

| 3 flags | optional field 2 | bits | |
|---|---|---|---|
| 1XX | LTW_Valid flag | 1 | bit |
| | LTW offset | 15 | bits |
| X1X | piecewise rate | 22 | bits |
| XX1 | splice type | 4 | bits |

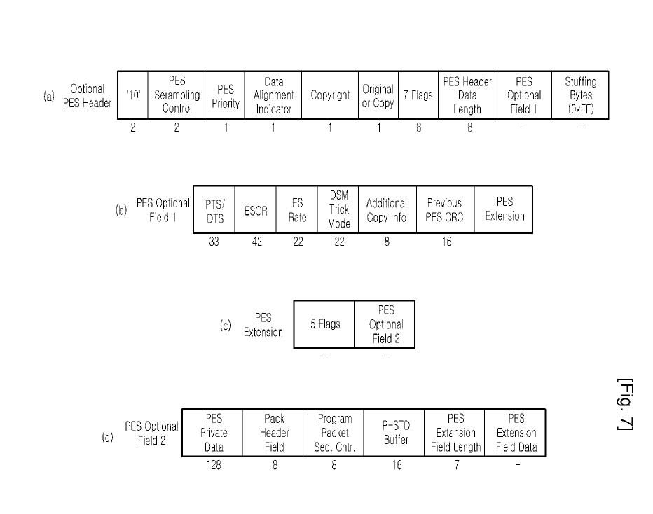

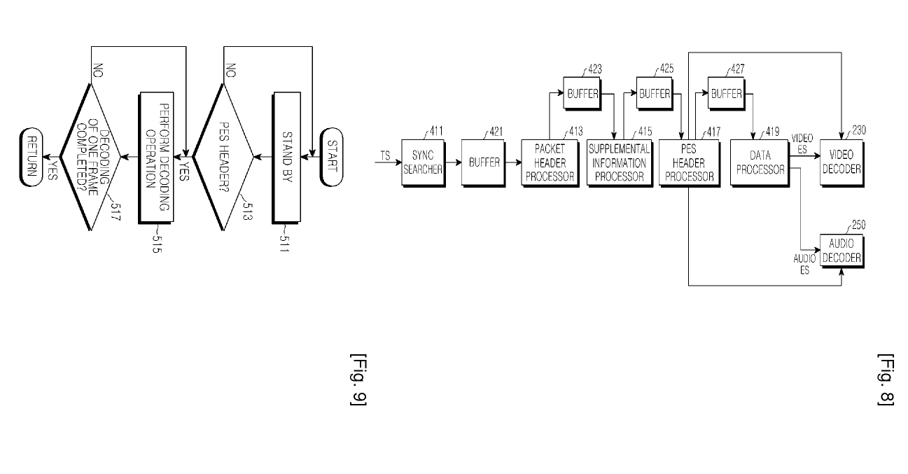

The PES header processor 417 and the data processor 419 process packets which the packet header processor 413 has determined as containing no supplemental information or which have been left after the processing in the supplemental information processor 415. The PES header processor 417 processes PES header information as illustrated in FIGS. 7a to 7d. FIG. 7a illustrates a PES header configuration, and the PES header contains PES scrambling control, PES priority, copyright, original/copy, 7 flags, PES data length, etc. and further contains PES optional field 1 if necessary. FIG. 7b illustrates a configuration of the PES optional field 1, and the PES optional field 1 contains Presentation Time Stamp (hereinafter referred to as “PTS”) and Decoding Time Stamp (hereinafter referred to as “DTS”). The PTS is time information for presenting data, which is decoded in the video decoder 230 or the audio decoder 250, on the display 150, and the decoder outputs the decoded data on the display 150 at a time of the PTS. The DTS is time information for starting on decoding by the video decoder 230 or the audio decoder 250, and the decoder starts to decode the inputted packet data at a time of the DTS. The 7 flags of the PES header illustrated in FIG. 7a and PES optional field 1 data according to the 7 flags are shown below in Table 4.

TABLE 4

| 5 flags | PES optional field 1 | bits |
|---|---|---|
| 0XXXXXX | PTS | 33 bits |
| 1XXXXXX | DTS | 33 bits |
| X1XXXXX | ESCR | 42 bits |
| XX1XXXX | ES rate | 22 bits |
| XXX1XXX | DSM trick mode | 22 bits |
| XXXX1XX | additional copy info | 8 bits |
| XXXXX1X | Previous PES CRC | 16 bits |
| XXXXXX1 | PES extension | variable |

If necessary, the PES optional field 1 may further have PES extension as illustrated in FIG. 7b. FIG. 7c illustrates a configuration of the PES extension, and the PES extension has 5 flags and may further have PES optional field 2 if necessary. FIG. 7d illustrates a configuration of the PES optional filed 2, and the PES optional filed 2 is determined by the 5 flags of the PES extension. That is, the 5 flags in FIG. 7c determine the contents of the PES optional field 2, which is shown below in Table 5.

TABLE 5

| 5 flags | PES optional field 2 | bits | |
|---|---|---|---|
| 1XXXX | PES private data | 128 | bits |
| X1XXX | pack header field | 8 | bits |
| XX1XX | program packet seq. cntr. | 8 | bits |
| XXX1X | PES extension field length | 16 | bits |
| XXXX1 | PES extension field data | 7 | bits |

The PES header processor 417 processes the PES header having the configuration as shown in FIGS. 7a to 7d, and transfers the remaining data excluding the PES header, that is, actual data ESs to the data processor 419. At this time, the data ESs transferred to the data processor 419 are ESs, from which the header information contained in the packet data are all removed, and the data processor 419 functions to distribute the transferred ES data into a video ES signal and an audio ES signal.

Further, if MPE data is contained in other data than the PES header information after the PES header processor 417 processes the PES header information, the PES header processor 417 transfers the other data including the MPE data to the MPE data processor (not illustrated). The MPE data processor extracts and processes the MPE data to generate IP data. If the generated IP data is transferred to the IP data processor (not illustrated), the IP data processor extracts and processes the IP data to generate UDP data. If the generated UDP data is transferred to the UDP data processor (not illustrated), the UDP data processor extracts and processes the UDP data to generate FLUTE data and RTP data. If the generated FLUTE data is transferred to the FLUTE data processor (not illustrated), the FLUTE data processor extracts and processes the FLUTE data to generate ESG data and/or file data. If the generated RTP data is transferred to the RTP data processor (not illustrated), the RTP data processor extracts and processes the RTP data to generate pure A/V data. The generated ESG data and/or file data and the generated pure A/V data are transferred to the data processor 419. The data processor 419 functions to distribute the transferred ESG data and/or file data and the transferred pure A/V data into a video ES, an audio ES or a data ES.

In the description of the demultiplexer 210 in FIG. 8, the first consideration is given to the demultiplexing operations for audio and video packets. However, in addition to the audio and video packets, there may be a data packet such as broadcast program information. Thus, in the case of such a data packet, the data processor 419 may further perform a function of distributing the data packet into a data ES. Also, the demultiplexed video, audio and data ESs are distributed to the video decoder 230, the audio decoder 250 and the data decoder (not illustrated) corresponding to them, respectively.

The decoders performs decoding operations when ES data inputted as stated above reaches a given size (generally a frame size). Thus, the decoders buffers ES data, which is demultiplexed in the demultiplexer 210, and analyzes the size of the buffered data. If the analysis shows that the buffered data reaches a frame size, the decoders start to decode the data. At this time, in this embodiment of the present invention, the PES header processor 417 controls the operations of the decoders at a point of time when it detects a PES header. That is, if the detected PES header is a video PES header, the PES header processor 417 issues a command to drive the video decoder 230. Also, if the detected PES header is an audio PES header, the PES header processor 417 issues a command to drive the audio decoder 250 and, if the detected PES header is a data PES header, the PES header processor 417 issues a command to drive the data decoder (not illustrated). Consequently, the decoders do not search for the buffered ES data, but access and decode frame data of the buffered ES data at a point of time when the PES header processor 417 issues the driving command.

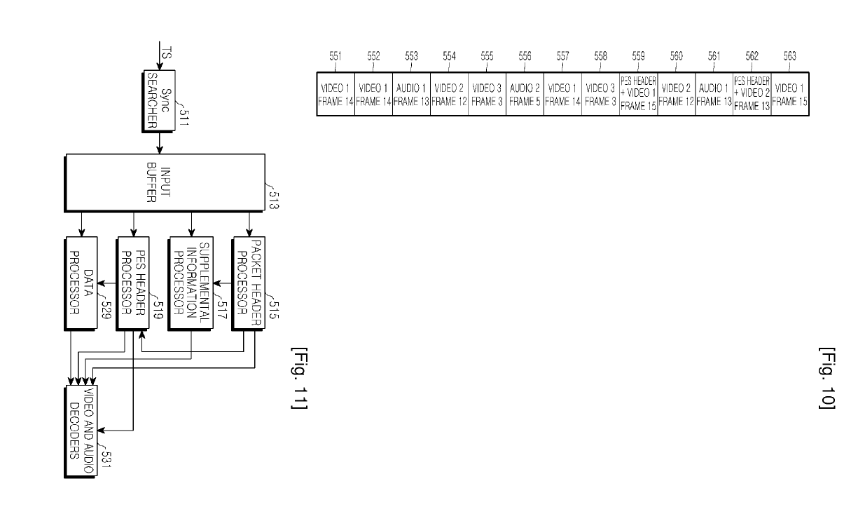

FIG. 9 is a flowchart illustrating operations of decoders according to a preferred embodiment of the present invention.

Referring to FIG. 9, in step 511, decoders stay in a standby state in which the decoder does not operate. In the standby state, powers supplied to the decoders may be interrupted. If detecting a PES header in such a state, the PES header processor 417 analyzes whether or not video, audio or data packets are received, and then issues a command for a corresponding decoder to perform decoding operations. At this time, the decoding operation command issued from the PES header processor 417 may be generated as an interrupt signal, or may be generated as a power supply signal for the decoder when the decoder is powered off. If the decoding operation command is issued, the decoder detects the beginning of frame data in step 513, and access the frame data stored in the input buffer 220 to perform decoding operations in step 515. Upon completion of decoding operations for one frame data, the decoder detects this in step 517, and stops the decoding operations to return to the standby state.

FIG. 10 is a view for explaining decoding operations using frame information of received TS data according to a referred embodiment of the present invention. FIG. 10 illustrates the classification of video and audio, information on each service (detailed channels), and frame information. In FIG. 10, reference numerals “559” and “562” correspond to packets containing a frame header, respectively. That is, reference numeral “559” designates frame 15 of PES header+video 1, and reference numeral “562” designates frame 13 of PES header+video 2. Here, reference numeral “559” indicates that a signal of video 1 is converted from frame 14 to frame 15, and reference numeral “562” indicates that a signal of video 2 is converted from frame 12 to frame 3. That is, looking into the TS data, it has a structure in which, owing to characteristics of a demultiplexing scheme, packetization starts at a beginning point of each frame, and a PES header of a corresponding frame is inserted at a point of time when the frame begins. Thus, based on things represented by the PES header, it can be seen that a new frame begins. The PES header processor 417 analyzes the type of a packet (audio, video, data, etc.) at a point where a packet containing a frame header, as designated by reference numeral “559” or “562” is received, and then issues a decoding operation command to a decoder for decoding the corresponding type of data. Then, the decoder receiving the decoding operation command performs the procedures illustrated in FIG. 9 to decode 1 frame-sized data. Therefore, by performing the decoding operations in this way, the standby operation of the decoder can be simplified to reduce a decoding burden, and power can be saved when the decoder is powered off in the standby state.

FIG. 11 illustrates another architecture of the demultiplexer unit 210, which has a different architecture from a serial architecture in FIG. 8, that is, a parallel architecture.

Referring to FIG. 11, a synchronization searcher 511 searches for a synchronization signal contained in each inputted packet data of a TS signal, and transfers the inputted packet data to a buffer 513. The synchronization searcher 511 according to this embodiment performs synchronization by using a balance delay scheme. The buffer 513 buffers serial data outputted from the synchronization searcher 511 in units of a packet.

A packet header processor 515 searches for packet header information outputted in parallel from the packet data in the buffer 513 to check if supplemental information is contained in the packet data, and drives only a PES header processor 519 when the supplemental information is not contained, but further drives an supplemental information processor 517 when the supplemental information is contained. The packet header processor 515 extracts packet header information from the inputted packet to process the extracted packet header information, and transfers the remaining packet data excluding the packet header to the supplemental information processor 517 when the supplemental information is contained, but transfers the remaining packet data excluding the packet header to the PES header processor 519 when the supplemental information is not contained.

The supplemental information processor 517 is driven under the control of the packet header processor 515, analyzes and processes supplemental information contained in packet data if the packet data is transferred from the packet header processor 515, and transfers the remaining packet data excluding the supplemental information to the PES header processor 519.

The PES header processor 519 extracts PES header information from packet data transferred from the packet header processor 515 or the supplemental information processor 517 to process the extracted PES header information, and transfers the remaining packet data excluding the PES header information to a data processor 529.

However, if MPE data is contained in the remaining data excluding the PES header information after the PES header processor 517 processes the PES header information, the PES header processor 517 transfers the remaining data including the MPE data to a MPE data processor (not illustrated). The MPE data processor extracts and processes the MPE data to generate IP data. If the generated IP data is transferred to an IP data processor (not illustrated), the IP data processor extracts and processes the IP data to generate UDP data. If the generated UDP data is transferred to a UDP data processor (not illustrated), the UDP data processor extracts and processes the UDP data to generate FLUTE data and RTP data. If the generated FLUTE data is transferred to a FLUTE data processor (not illustrated), the FLUTE data processor extracts and processes the FLUTE data to generate ESG data and/or file data. If the generated RTP data is transferred to a RTP data processor (not illustrated), the RTP data processor extracts and processes the RTP data to generate pure A/V data. The generated ESG data and/or file data and the generated pure A/V data are transferred to the data processor 529.

The data processor 529 processes the packet data, from which the PES header is removed, to transfer the processed packet data to the input buffer of the video decoder 230 or the audio decoder 250. The data processor 529 also processes the pure A/V data to transfer the processed pure A/V data to the input buffer of the video decoder 230 or the audio decoder 250, and processes the ESG data and/or file data to transfer the processed ESG data and/or file data to a data buffer (not illustrated).

As stated above, the demultiplexer unit 210 includes 4 processors 515 to 529. Each processor 515 to 529 sequentially analyzes the packet data buffered in the buffer 513, and accesses the packet data from the buffer 513 to process the packet data only when information to be processed thereby is contained in the packet data. Here, the packet data may has a configuration including a packet header, a supplemental information header and a PES header, and information on these headers may or may not be contained in the packet header. Thus, each processor 515 to 529 is driven to process header information only when header information to be processed thereby is contained, and such data processing may be conducted in parallel.

When the demultiplexer 210 has the parallel architecture as illustrated in FIG. 11, the processors analyze buffered packet, and information contained in the packet are processed in parallel by the respective corresponding processors, so that a demultiplexing speed can be improved. Further, since the respective processors access and process packets buffered in one buffer, the buffer can be simply constructed, and simultaneously a data transport time can be reduced. At this time, the PES header processor 519 can initialize decoders on a frame-by-frame basis by issuing a command to operate a corresponding decoder when a PES header is confirmed, as stated above.

If the PES header processor 510 detects a PES header to issue a decoding operation command while the decoders stay in the standby state or are powered off, a corresponding decoder is released from the standby state, and performs operations of decoding one received frame data.

Therefore, the decoders need not spend an excessive turn-on time on header search procedures other than decoding operation procedures. As a result of this, a standby time and a search procedure, which are practically unnecessary, can be omitted, and thus decoding efficiency can be improved.

As described above, in a digital broadcast receiver according to the present invention, a PES header processor of a demultiplexer analyzes whether or not frame headers of a received packet are received, and issues a decoding operation command to operate decoders when the frame headers are confirmed. Decoders corresponding to the confirmed frame headers perform decoding operations when receiving the decoding operation command. Accordingly, the decoders need not spend an excessive turn-on time on header search procedures other than decoding operation procedures. As a result of this, a standby time and a search procedure, which are practically unnecessary, can be omitted, and thus decoding efficiency can be improved.

While the invention has been shown and described with reference to a certain preferred embodiment thereof, it will be understood by those skilled in the art that various changes in form and details may be made therein without departing from the spirit and scope of the invention as defined by the appended claims and equivalents thereof.

1. A digital broadcast transmitter/receiver comprising:
a tuner for selecting a channel of a received digital broadcast signal through channel selection by a controller unit;
a demodulator for demodulating a signal of the selected digital broadcast channel;
a demultiplexer for separating audio, video and data streams of a selected program identifier from the demodulated broadcast signal to demultiplex the streams to corresponding decoders, respectively, and issuing a decoding operation command when a frame header is detected in the streams;
a video decoder for decoding a demultiplexed video frame when the decoding operation command is issued;
an audio decoder for decoding a demultiplexed audio frame when the decoding operation command is issued; and
a display unit for displaying decoded video and audio data.

2. The digital broadcast transmitter/receiver as claimed in claim 1, wherein the demultiplexer comprises:
a packet header processor for analyzing a packet header of a stream outputted from the demodulator, and bypassing a packet excluding the packet header;
a supplemental information processor for processing supplemental information contained in a packet outputted from the packet header processor, and bypassing a remaining packet excluding the supplemental information;
a PES header processor for processing PES header information contained in a packet outputted from the supplemental information processor, issuing a decoding operation command to the corresponding video or audio decoder according to packet types when the PES header is contained, and bypassing a remaining packet excluding the PES header; and
a data processor for generating actual data, which is contained in a packet outputted from the PES header processor, into ES data to demultiplex the generated ES data to the corresponding video or audio decoder.

3. The digital broadcast transmitter/receiver as claimed in claim 1, wherein the demultiplexer comprises:
a packet header processor for analyzing a header of a buffered packet to drive a corresponding processor according to whether or not supplemental information and/or a PES header are/is contained;
a supplemental information processor being driven by the packet header processor to process the supplemental information contained in the buffered packet;
a PES header processor being driven by the packet header processor to process PES header information contained in the buffered packet and to issue a decoding operation command to the corresponding video or audio decoder according to packet types; and
a data processor for generating actual data contained in the buffered packet into ES data to demultiplex the generated ES data to the corresponding video or audio decoder while being driven under the control of the PES header processor.

4. The digital broadcast transmitter/receiver as claimed in claim 2, wherein the demultiplexer further comprises:
a MPE data processor for extracting and processing MPE data to generate IP data if the MPE data is contained in the packet outputted from the PES header processor, and transferring the generated IP data to an IP data processor;
the IP data processor for extracting and processing the transferred IP data to generate UDP data, and transferring the generated UDP data to a UDP data processor;
the UDP data processor for extracting and processing the transferred UDP data to generate FLUTE data and RTP data, transferring the generated FLUTE data to a FLUTE data processor, and transferring the generated RTP data to a RTP data processor;
the FLUTE data processor for extracting and processing the transferred FLUTE data to generate ESG data and file data, and transferring the generated ESG data and file data to the data processor; and
the RTP data processor for extracting and processing the transferred RTP data to generate pure A/V data, and transferring the generated pure A/V data to the data processor.

5. The digital broadcast transmitter/receiver as claimed in claim 2 or 3, wherein every time the decoding operation command is issued, the video or audio decoder operates to decode demultiplexed and frame-sized data, and transitions to a standby state after completion of decoding the data.

6. A decoding method in a digital broadcast transmitter/receiver, the method comprising the steps of:
selecting a channel of a received digital broadcast signal through channel selection by a controller unit;
demodulating a signal of the selected digital broadcast channel;
separating audio, video and data streams of a selected program identifier from the demodulated broadcast signal to demultiplex the streams to corresponding decoders, respectively, and issuing a decoding operation command when a frame header is detected in the streams;
decoding a demultiplexed video frame or a demultiplexed audio frame when the decoding operation command is issued; and
displaying decoded video and audio data.

7. The decoding method as claimed in claim 6, wherein the step of demultiplexing the separated streams comprises the substeps of:
analyzing a packet header of a stream outputted from the demodulator to process the analyzed packet header, and bypassing a packet excluding the packet header;
processing supplemental information contained in a packet outputted after the substep of processing the packet header, and bypassing a remaining packet excluding the supplemental information;
processing PES header information contained in a packet outputted in the substep of processing the packet header, issuing a decoding operation command to the corresponding video or audio decoder according to packet types when the PES header is contained, and bypassing a remaining packet excluding the PES header; and
generating actual data, which is contained in a packet outputted in the substep of processing the PES header, into ES data to demultiplex the generated ES data to the corresponding video or audio decoder.

8. The decoding method as claimed in claim 6, wherein the step of demultiplexing the separated streams comprises the substeps of:
analyzing a packet header of a buffered packet to perform a corresponding processing procedure according to whether or not supplemental information andor a PES header are/is contained;
when processing of the supplemental information is driven in the substep of processing the packet header, operating to process the supplemental information contained in the buffered packet;
when processing of the PES header is driven in the substep of processing the packet header or the supplemental information, operating to process PES header information contained in the buffered packet and to issue a decoding operation command to the corresponding video or audio decoder according to packet types; and
after the substep of processing the PES header, generating actual data contained in the buffered packet into ES data to demultiplex the generated ES data to the corresponding video or audio decoder.

9. The decoding method as claimed in claim 7, wherein the step of demultiplexing the separated streams further comprises the substeps of:
determining if MPE data is contained in a packet outputted in the substep of processing the PES header;
if the MPE data is contained, extracting and processing the MPE data to generate IP data;
extracting and processing the IP data to generate UDP data;
extracting and processing the UDP data to generate FLUTE data and RTP data;
extracting and processing the FLUTE data to generate ESG data and file data, and extracting and processing the RTP data to generate pure A/V data; and
demultiplexing the generated ESG data, file data and pure A/V data to corresponding decoders.

10. The decoding method as claimed in claim 7 or 8, wherein every time the decoding operation command is issued, the step of decoding the video or audio frame is operated to decode demultiplexed and frame-sized data, and transition to a standby state is performed after completion of decoding the data.

11. A decoding method in a digital broadcast transmitter/receiver, the method comprising the steps of:
separating audio, video and data streams of a selected program identifier from a demodulated broadcast signal to demultiplex the streams to corresponding decoders, respectively, and issuing a decoding operation command when a frame header is detected in the streams; and
when the decoding operation command is issued, decoding one demultiplexed frame data, and transitioning to a standby state after completion of decoding the data.
